(19) United States
(12) Patent Application Publication
(10) Pub. No.: US 2009/0235905 A1
(43) Pub. Date: Sep. 24, 2009

(54) Device for swirling and mixing exhaust gases recycled in the intake duct of an internal combustion engine

(75) Inventor: Thierry Marimbordes, Bazougers (FR)

Correspondence Address: Mann+Hummel GMBH, Dept: VR-P Plant 5.4, Hindenburgstr. 45, Ludwigsburg, 71638, DE

(73) Assignee: MANN+HUMMEL GMBH, Ludwigsburg (DE)

(21) Appl. No.: 12/237,438

(22) Filed: Sep. 25, 2008

(30) Foreign Application Priority Data
Sep. 25, 2007 (FR) 07 57 816

(51) Int. Cl. F02M 25/07

(52) U.S. Cl. 123/568.17

(57) ABSTRACT

Disclosed is a device for swirling and mixing exhaust gases recycled in the intake duct (1) of an internal combustion engine via a recycling conduit (2). The device is formed of two control flaps (3, 4) in the form of toroidal portions, mounted rotatably about axes of articulation (6, 7), the control flaps (3, 4) being displaceable in rotation between, on the one hand, a rest position in which they are retracted along the inner wall of the intake duct (1) so as to expose the entire cross-section of said duct and, on the other hand, an active position in which they are pulled towards one another so as to reduce said cross-section, and also formed of an actuator which makes it possible to control displacement of the control flaps (3, 4) between the active position and rest position thereof.

### TECHNICAL FIELD

The present invention relates to a device for swirling and mixing the exhaust gases recycled in the intake duct of an internal combustion engine via a recycling conduit, substantially perpendicularly to the longitudinal axis of the intake duct.

### BACKGROUND OF THE INVENTION

It is normal to recycle some of the exhaust gases of an internal combustion engine towards the cylinders of said engine. Exhaust gas recirculation (EGR) works by recirculating a portion of internal combustion engine exhaust gas back into the engine cylinders. This intermixing of the incoming combustion air with EGR recirculated exhaust gas dilutes the mix with relatively inert gas depleted of oxygen, thereby lowering the adiabatic flame temperature and (in diesel engines) reducing the amount of excess oxygen. The recycled exhaust gas also increases the specific heat capacity of the mix lowering the peak combustion temperature. Because NOx formation progresses much faster at high temperatures, EGR serves to limit the generation of NOx. NOx is primarily formed when a mix of nitrogen and oxygen is subjected to high temperatures.

Generally, EGR introduces the recycled exhaust gas into the intake duct of the internal combustion engine via a recycling conduit. A system of this type slows down combustion of the mixture in the combustion chambers of the internal combustion engine and absorbs some of the heat, which reduces the combustion temperature. These two effects (limiting of oxygen and reduction in combustion temperature) lead to a reduction of nitrogen oxides NOx.

Unfortunately, the past methods and apparatus for mixing exhaust gases for re-introduction into the internal combustion engine have disadvantages. For satisfactory performance the mixture of intake air and recycled exhaust gasses must be as homogeneous as possible. As can be seen, there is a need for an improved device for swirling and mixing the exhaust gases recycled in the intake duct of an internal combustion engine.

### SUMMARY OF THE INVENTION

The present invention provides a device for swirling and mixing recycled exhaust gases inside the intake duct (1) of an internal combustion engine.

According to one aspect of the invention, the device includes a recycling conduit (2), substantially perpendicularly to the longitudinal axis of said intake duct, two hinge pins (6, 7) positioned substantially perpendicular to the longitudinal axis of said intake duct (1). Also included are two control flaps (3, 4) in the form of toroidal portions, mounted rotatably on the inner part of the intake duct (1), about the hinge pins substantially perpendicular to the longitudinal axis of said intake duct (1) as well as to the axis of introduction of the exhaust gases recycled in said duct. The control flaps (3, 4) are displaceable in rotation between, on the one hand, a rest position in which they are retracted along the inner wall of the intake duct (1) so as to expose the entire cross-section of said duct and, on the other hand, an active position in which they are pulled towards one another so as to reduce said cross-section. Also included is an actuator driveably engaged to a hinge pin and operable to control displacement of the control flaps (3, 4) between the active position and the rest position as a function of the pressure of the recycled exhaust gases introduced into the intake duct (1) via the recycling conduit (2).

In another aspect of the invention, the inner wall of the intake duct (1) includes cavities (10) in which the control flaps (3, 4) are arranged in the rest position thereof.

In another aspect of the invention, the control flaps (3, 4) are mounted together in rotation.

In another aspect of the invention, the hinge pins (6, 7) of the control flaps (3, 4) are each fitted with toothed portions (8, 9) which engage with one another during displacement of said flaps between the active position and rest position thereof.

In another aspect of the invention, the control flaps (3, 4) are arranged after the recycling conduit (2) in the direction of circulation of the air flow drawn into the intake duct (1).

In another aspect of the invention, the control flaps (3, 4) are arranged before the recycling conduit (2) in the direction of circulation of the air flow drawn into the intake duct (1).

The above features and advantages and other features and advantages of the present invention are readily apparent from the following detailed description of the best modes for carrying out the invention when taken in connection with the accompanying drawings.

### BRIEF DESCRIPTION OF THE DRAWINGS

FIG. 1 is a cross-section of the intake duct showing the control flaps in the rest position, consistent with the present invention;

FIG. 2 is a cross-section of the intake duct similar to that of FIG. 1 but showing the control flaps in the active position;

FIG. 3 is a perspective view of the intake duct showing the shaft for controlling the control flaps; and

FIG. 4 is a schematic end view of the intake duct illustrating an actuator driveably engaged to a hinge pin of the control flaps to control the position of the flaps between the active and rest positions.

### DESCRIPTION OF THE PREFERRED EMBODIMENTS

An EGR system slows down combustion of the mixture in the combustion chambers of the internal combustion engine and absorbs some of the heat, which reduces the combustion temperature. In addition, it limits the presence of oxygen in the cylinders. These two effects lead to a reduction of nitrogen oxides NOx.

However, in order for a system of this type to function in a satisfactory manner, the mixture of air and recycled burned gases must be as homogeneous as possible.

The invention thus relates to a device for swirling and mixing the exhaust gases recycled in the intake duct of an internal combustion engine, making it possible to control homogenization of the mixture of air and recycled exhaust gases which circulates in this pipeline.

According to the invention, a device of this type is characterized in that it is formed of two control flaps in the form of toroidal portions mounted rotatably on the inner part of the intake duct, and also of an actuator which makes it possible to control the rotation of said control flaps.

The hinge pins of the two control flaps are substantially perpendicular to the longitudinal axis of the intake duct as well as to the axis of introduction of the recycled exhaust gases into said duct via the recycling conduit.

According to the invention, the control flaps are displaceable in rotation between, on the one hand, a rest position in which they are retracted along the inner wall of the intake duct so as to expose the entire cross-section of said intake duct and, on the other hand, an active position in which they are pulled towards one another so as to reduce said cross-section.

The actuator, which may for example be controlled mechanically, pneumatically or electrically, ensures that displacement of the control flaps between the active position and the rest position thereof is controlled as a function of the pressure of the recycled burned gases introduced into the intake duct via the recycling conduit.

More precisely, in the absence of recycled burned gases or when the pressure of these gases is lower than a predetermined threshold value, the actuator controls the control flaps so they remain in the rest position.

In contrast, when this pressure increases, the actuator controls said flaps so they are displaced towards the active position, in which the exposed cross-section is generally reduced to approximately 30% of the nominal cross-section of the intake duct.

In an active position, the control flaps act like the blades of a turbine to swirl the mixture of air and recycled burned gases and, consequently, enable this mixture to be homogenized quickly, the mixture then optionally being transferred towards an air distributor.

The shape of these flaps is of course adapted to the requirements in each case.

According to a particularly advantageous feature of the invention, the inner wall of the intake duct comprises cavities in which the control flaps are arranged in the rest position thereof. Consequently, in the rest position, that is to say in the absence or near absence of recycled exhaust gases, the presence of control flaps does not lead to any loss of pressure in the air flow drawn into the intake duct.

In accordance with the invention, the control flaps are preferably mounted jointly in rotation. Consequently, their hinge pins may advantageously each be fitted with toothed portions which engage in one another during displacement of said flaps between the active position and rest position thereof. These toothed portions are generally also arranged in the cavities formed in the inner wall of the intake duct. Taking into account this configuration, only the end which is held directly or indirectly by the actuator, of one of the hinge pins of the control flaps or engine shaft, projects from the outer part of the intake duct. The second hinge pin which is driven by said engine shaft by means of the toothed portions is arranged entirely in the inner part of the intake duct.

According to the invention, the control flaps are preferably mounted after the recycling conduit in the direction of circulation of the air flow drawn into the intake duct.

However, these control flaps may also be mounted before said conduit without departing from the scope of the invention.

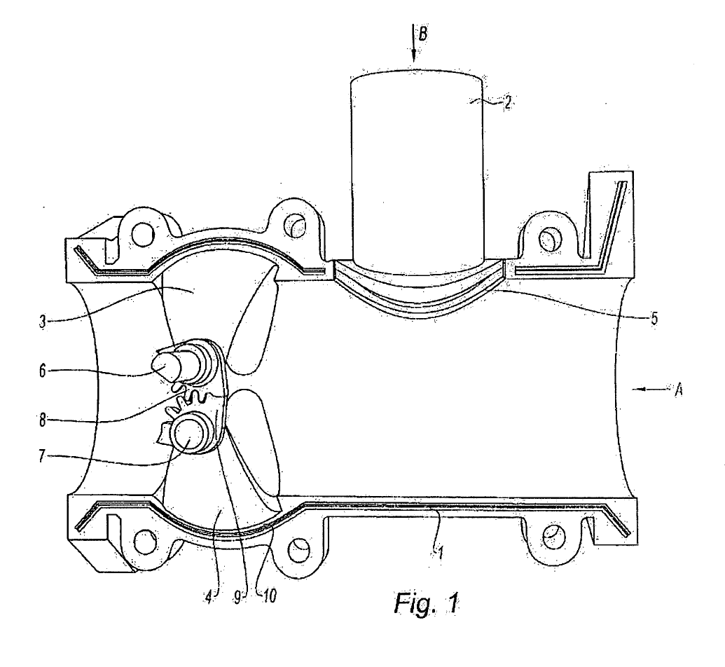

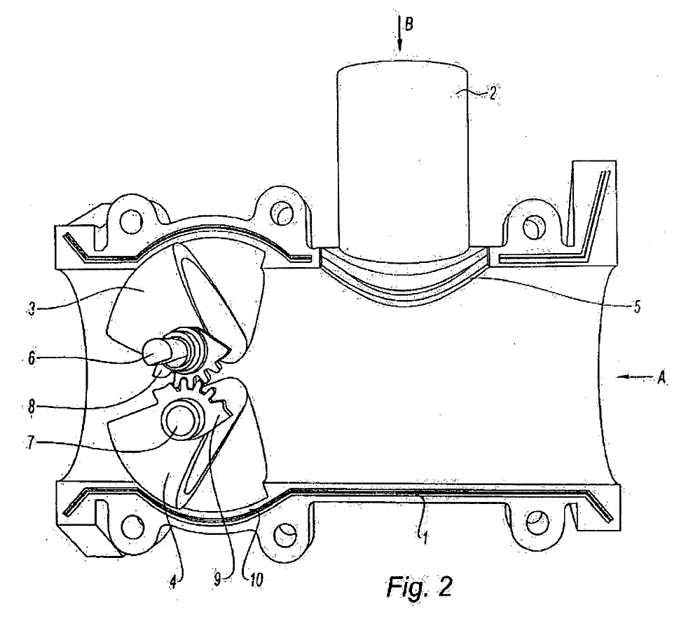

The discussion is now directed to the attached FIGS. 1-4. According to FIG. 1 and 2, an air flow indicated by the arrow A circulates inside the intake duct 1 of an internal combustion engine so as to be transferred towards the cylinders of said engine.

Some of the exhaust gases of said engine, generally corresponding to between 5 and 35% of these gases, are recycled inside the intake duct 1 via a recycling conduit 2 according to the arrow B.

The axis of introduction B of the recycled exhaust gases into the intake duct 1 is perpendicular to the longitudinal axis A of said conduit.

According to FIGS. 1 and 2, two control flaps 3, 4 are mounted on the inner part of the intake duct 1 after the feed opening 5 of the exhaust gases recycled via the recycling conduit 2.

These two control flaps 3, 4 which are in the form of toroidal portions are mounted jointly in rotation about parallel hinge pins 6, 7 respectively.

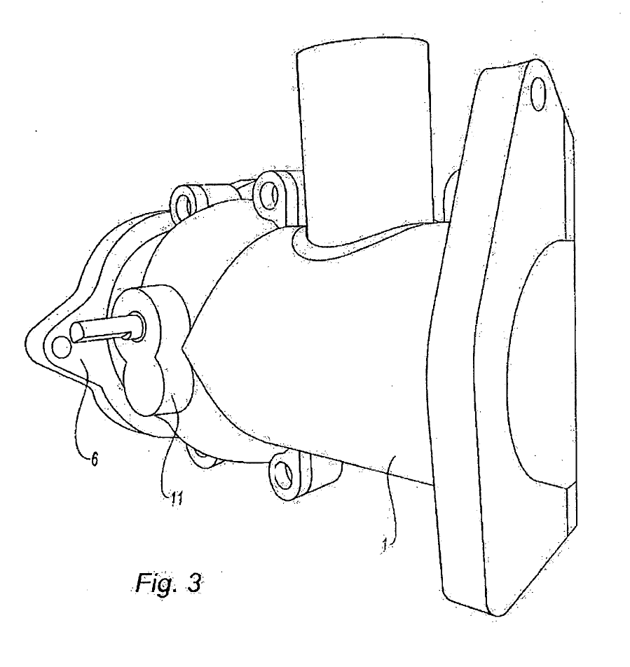

According to FIGS. 1, 2 and 3, one of these axes of articulation 6, corresponding to an engine shaft, projects from the outer part of the intake duct 1, as shown in FIG. 3. Said engine shaft is driven directly or indirectly by an actuator not shown in the figures.

The second hinge pin 7 is driven by the engine shaft 6 by means of two toothed portions 8, 9 fixed jointly to said pin and shaft respectively, which portions engage in one another during rotation thereof.

The control flaps 3, 4 may also be displaced between a rest position shown in FIG. 1 in which they are retracted along the inner wall of the intake duct 1 and an active position shown in FIG. 2 in which they are pulled towards one another.

This displacement of the control flaps 3, 4 between these two positions is controlled by the actuator (not shown in the figures) as a function of the pressure of the exhaust gases recycled according to the arrow B in the intake duct 1 via the recycling conduit 2.

According to FIG. 1, when the pressure of the recycled exhaust gases is lower than a predetermined threshold, the actuator controls the control flaps 3, 4 so as to be positioned in the rest position in order to expose the entire cross-section of the intake duct 1, as shown in FIG. 1.

According to FIG. 2, when the pressure of the recycled exhaust gases increases, the actuator controls the control flaps 3, 4 so they are displaced towards the active position in order to reduce said cross-section.

In the active position, the control flaps 3, 4 cause the mixture of air and recycled exhaust gases to swirl and circulate within the inner part of the intake duct 1, and this leads to homogenization of this mixture.

According to FIGS. 1 and 2, the inner wall of the intake duct 1 includes cavities 10 in which the control flaps 3, 4 are arranged in the rest position thereof, as shown in FIG. 1, in such a way that there is no loss of pressure in the gaseous flow circulating inside the intake duct 1 in the direction of arrow A.

According to FIG. 3 and for a similar reason, the toothed portions 8, 9 are also arranged in cavities 11 formed in the inner wall of the intake duct 1.

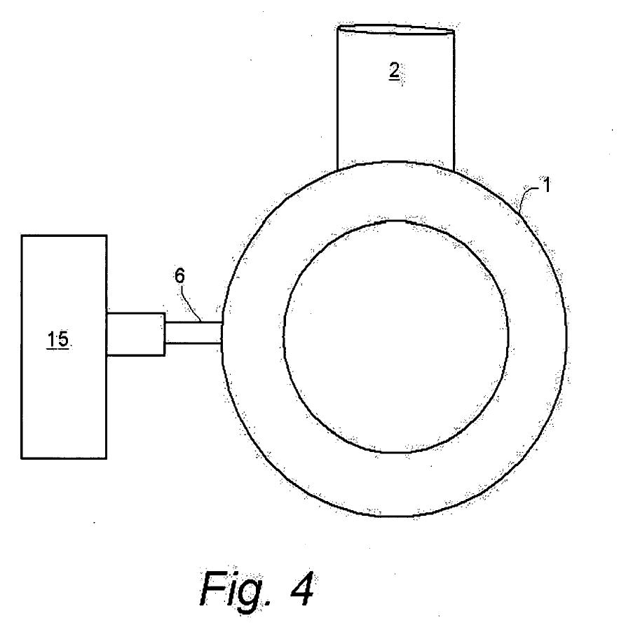

FIG. 4 illustrates a schematic end view of the intake duct 1 with an actuator 15 driveably engaged to a hinge pin 6 of the control flaps 3 and 4, operative to control the position of the flaps between the active and rest positions. The actuator is configured to control the position of the control flap 3 and 4 as a function of the pressure of the recycled exhaust gases introduced into the intake duct (1) via the recycling conduit (2).

While the best modes for carrying out the invention have been described in detail, those familiar with the art to which this invention relates will recognize various alternative designs and embodiments for practicing the invention within the scope of the appended claims.

1. A device for swirling and mixing recycled exhaust gases inside the intake duct (1) of an internal combustion engine, comprising:
a recycling conduit (2), substantially perpendicularly to the longitudinal axis of said intake duct;
two hinge pins (6, 7) positioned substantially perpendicular to the longitudinal axis of said intake duct (1);
two control flaps (3, 4) in the form of toroidal portions, mounted rotatably on the inner part of the intake duct (1), about said hinge pins substantially perpendicular to the longitudinal axis of said intake duct (1) as well as to the axis of introduction of the exhaust gases recycled in said duct, said control flaps (3, 4) being displaceable in rotation between, on the one hand, a rest position in which they are retracted along the inner wall of the intake duct (1) so as to expose the entire cross-section of said duct and, on the other hand, an active position in which they are pulled towards one another so as to reduce said cross-section; and
an actuator driveably engaged to a hinge pin and operable to control displacement of the control flaps (3, 4) between the active position and the rest position as a function of the pressure of the recycled exhaust gases introduced into the intake duct (1) via the recycling conduit (2).

2. The device according to claim 1, wherein the inner wall of the intake duct (1) comprises cavities (10) in which the control flaps (3, 4) are arranged in the rest position thereof.

3. The device according to either claim 1 or claim 2, wherein the control flaps (3, 4) are mounted together in rotation.

4. The device according to claim 3, wherein the hinge pins (6, 7) of the control flaps (3, 4) are each fitted with toothed portions (8, 9) which engage with one another during displacement of said flaps between the active position and rest position thereof.

5. The device according to any one of claims 1 to 4, wherein the control flaps (3, 4) are arranged after the recycling conduit (2) in the direction of circulation of the air flow drawn into the intake duct (1).

6. The device according to any one of claims 1 to 4, wherein the control flaps (3, 4) are arranged before the recycling conduit (2) in the direction of circulation of the air flow drawn into the intake duct (1).
